(19) United States
(12) Patent Application Publication
(10) Pub. No.: US 2026/0264781 A1
(43) Pub. Date: Sep. 10, 2026

(54) SMART FOOT SYSTEM FOR ENHANCED ROBOT MOBILITY ON TERRAINS

(71) Applicant: Georgia Tech Research Corporation, Atlanta, GA (US)

(72) Inventors: Deniz KERIMOGLU, Atlanta, GA (US); Burak CATALBAS, Atlanta, GA (US); Bahadir CATALBAS, Atlanta, GA (US); Daniel I. GOLDMAN, Atlanta, GA (US)

(21) Appl. No.: 19/557,953

(22) Filed: Mar. 5, 2026

Related U.S. Application Data
(60) Provisional application No. 63/767,442, filed on Mar. 5, 2025.

(51) Int. Cl. B62D 57/032; B25J 9/16; B25J 15/00

(52) U.S. Cl. CPC B62D 57/032; B25J 9/1697; B25J 15/0019

(57) ABSTRACT

An exemplary foot system and method for improving the locomotion of legged robots across diverse terrains using motorized, movable, or retractable cleats. The foot system may include movable cleats coupled to at least one guided assembly, a sole section having a set of slits, wherein the sole section is configured to be in mechanical contact with a ground surface comprising soft soil or hard soil, a casing section fixably coupled to the sole section to form a housing to encapsulate the set of movable cleats and the guided assembly, or a portion thereof; and a controller configured to direct an actuator located in the casing section to move the set of movable cleats through the set of slits between a stowed position distal to the sole section and a deployed position proximal to the sole section along a substantial portion of the housing.

### RELATED APPLICATION

This application claims priority to, and the benefit of, U.S. Provisional Patent Application No. 63/767,442, filed Mar. 5, 2025, entitled “SMART FOOT SYSTEM FOR ENHANCED ROBOT MOBILITY ON TERRAINS,” which is incorporated by reference herein in its entirety.

### GOVERNMENT SPONSORSHIP CLAUSE

This invention was made with government support under 2328254 awarded by the National Science Foundation. The government has certain rights in the invention.

### BACKGROUND

Current robotic platforms primarily focus on locomotion and operation in structured environments such as homes, factories, highways, and streets. These robots can navigate reliably in relatively predictable and controlled settings by relying on predictable ground interactions to perform various tasks. However, robots must also achieve stable locomotion in unpredictable, challenging terrain such as natural environments and hazardous areas where human operation is difficult, enabling tasks such as exploration, load carrying, and infrastructure maintenance. Flowable and deformable surfaces that can deform unpredictably under stress, such as sandy deserts, snowy mountains, and extraterrestrial environments, pose great challenges for robot locomotion.

Various foot systems have been developed for robotic platforms guided by speed, stability, and reliability objectives. However, these foot systems primarily focus on actuating multi-segmented foot mechanisms designed for the robot's interaction with rigid surfaces. For human walking augmentation, systems have been designed with feature extensions that protrude passively from the shoe sole. Other systems introduce a transformable shoe for human walking that is equipped with sensors and actuators that adapt to various terrains.

There is a benefit to improving locomotion for the robots to accommodate a various terrain types and surface conditions, including those that are uneven, deformable, or unpredictable.

### SUMMARY

An exemplary foot system and method are disclosed for improving the locomotion of legged robots across diverse terrains using motorized, movable, retractable cleats. The exemplary foot system and method can facilitate bipedal and quad pedal robots, and the like, to traverse terrains in which dynamic traction is critical, such as sandy slopes, arid and granular environments, snowy inclines, and sloped extraterrestrial surfaces, by providing active, adaptive ground engagement. In some implementations, the movable cleats are (i) deployed on flowable and deformable surfaces to improve stability and (ii) retracted on rigid surfaces to increase locomotion efficiency. The exemplary system and method can be implemented on legged robots of various sizes and leg counts, supporting broad commercial scalability.

Current robotic feet are configured for rigid surfaces and often fail locomotion on deformable and flowable surfaces. Although some robotic feet are configured for granular surfaces, they lack adaptability across terrain types and cannot transition between granular and rigid environments. Additionally, no current robotic feet provide active control over the flow and deformation of soft surfaces (e.g., sand, snow) to improve the propulsion or foothold stability of the robots. In contrast, the exemplary system and method can manipulate the flow and deformation of soft, flowable surfaces (e.g., sandy, snowy slopes), via motorized control of the movable cleats that extend from the foot sole, facilitating smooth transitions between rigid and soft terrains for robots.

When extended into deformable or flowable media, the movable cleats of the exemplary system and method can maintain the substrate (e.g., sand, snow) at or below its yield stress by creating localized constraints and reducing the material flowability. This mechanism can prevent destabilizing terrain responses, such as avalanching or excessive slippage, that can be triggered by robotic foot interactions on steep or flowable slopes. The movable cleats can be spaced to enhance grip and traction, facilitating the robots to establish a secure foothold and execute stable steps. The extension depth of the movable cleats can be adjusted based on the flowability of the terrain. For highly flowable or steep slopes, the movable cleats can be fully deployed, whereas partial deployment can suffice for shallower or less flowable environments.

In some implementations, the exemplary system and method sense properties of the ground and control cleat extension or retraction without sensing technologies. For example, when the movable cleats extend and contact a surface, the load on a motor controlling the movable cleats increases (e.g., indicated by an increase in the motor's current draw). Thresholding of the current values can allow the exemplary system and method to distinguish between penetrable (e.g., sand, snow) and non-penetrable (e.g., rigid) substrates. Based on this distinction, the movable cleats can retract or yield upon contact with a rigid surface and extend upon contact with a soft surface, which can help the robots transition between heterogeneous terrains, enhancing their operational versatility.

In some implementations, the movable cleats yield when insufficient motor torque is available to counter the ground reaction forces experienced upon impact with a non-penetrable surface. For example, when the exemplary foot system contacts a solid ground, an initial contact occurs between the movable cleats and the ground. If the ground reaction force exceeds the motor torque at its threshold current, the movable cleats can be forced back into the foot structure. Current continues to flow in the motor so that the motor can keep generating torque. However, the motor torque is insufficient to maintain cleat extension against the opposing force, causing passive retraction without any contact-triggered control command. Once the exemplary foot system is lifted and the opposing force is removed, the movable cleats can automatically extend outward again, provided no external force prevents their deployment. The passive yield of movable cleats can enable rapid, robust adaptation to changing ground conditions.

In some implementations, the exemplary foot system and method operate independently of the main control of the robots, which can reduce the reaction time when deploying or retracting the cleats, allowing the robots to adapt rapidly to changing surface conditions and improving their robustness in dynamic environments.

In an aspect, a foot system for a legged robot (e.g., bipedal, quad pedal robot, etc.) is disclosed comprising: a set of movable cleats coupled to at least one guided assembly, including a first guided assembly, or a portion thereof; a sole section having a set of slits, wherein the sole section is configured to be in mechanical contact with a ground surface including soft soil or hard soil; a casing section fixably coupled to the sole section to form a housing to encapsulate the set of movable cleats and the guided assembly, or a portion thereof; and a controller configured to direct an actuator located in the casing section to move the set of movable cleats through the set of slits between a stowed position distal to the sole section and a deployed position proximal to the sole section along a substantial portion of the housing.

In some embodiments, the at least one guided assembly is configured to (i) move the set of movable cleats through the set of slits from the stowed position to the deployed position, to extend the set of movable cleats into the ground surface; and (ii) move the set of movable cleats through the set of slits from the deployed position to the stowed position, to retract the set of movable cleats from the ground surface.

In some embodiments, the first guided assembly comprises: a frame fixably coupled to the set of movable cleats; and at least one guide threaded shaft (e.g., lead screw), including a first guide threaded shaft operatively coupled to the frame, wherein the first guide threaded shaft includes (i) a threading portion extending through the frame within the housing and (ii) a head portion protruding the casing section, wherein the threading portion is configured to rotationally and/or linearly actuate to move, via the frame within the first guided assembly, the set of movable cleats through the set of slits between the stowed position and the deployed position.

In some embodiments, the foot system described herein further comprises: at least one actuator, including a first actuator as the actuator operatively coupled to the first guide threaded shaft, or the head portion thereof, wherein the first actuator is configured to drive (e.g., via a timing belt) the head portion of the first guide threaded shaft to cause the threading portion of the first guide threaded shaft to rotationally and/or linearly actuate to move, via the frame within the first guided assembly, the set of movable cleats through the set of slits between the stowed position and the deployed position.

In some embodiments, the controller is configured to actuate the at least one actuator to drive the head portion of the at least one guide threaded shaft to cause the threading portion of the at least one guide threaded shaft to rotationally and/or linearly actuate to move, via the frame within the at least one guided assembly, the set of movable cleats through the set of slits from the stowed position to the deployed position, to extend the set of movable cleats into the ground surface; determine an amount of current drawn by the at least one actuator when the at least one actuator drives the head portion of the at least one threaded shaft; and in response to the determined amount of current exceeding a predefined current threshold, yield by allowing the set of moveable cleats to move from the deployed position to the stowed position, or actuate the at least one actuator to drive the head portion of the at least one guide threaded shaft to cause the threading portion of the at least one guide threaded shaft to rotationally and/or linearly actuate to move, via the frame within the at least one guided assembly, the set of movable cleats through the set of slits from the deployed position to the stowed position, to retract the set of movable cleats from the ground surface.

In some embodiments, the foot system described herein further comprises: a sensor (e.g., camera) situated within the housing, wherein the sensor is configured to capture an image of the ground surface, and wherein the controller is configured to: receive, via the sensor, the captured image of the ground surface; determine, via a detection algorithm or a trained AI model, type of the ground surface using the received captured image at every predefined period of time (e.g., every 1 second); and actuate the first actuator to drive the head portion of the first guide threaded shaft, based on the determined type of the ground surface.

In some embodiments, in response to the determined type of the ground surface being granular, the controller is further configured to actuate, in a first direction, the first actuator to drive the head portion of the first guide threaded shaft to cause the threading portion of the first guide threaded shaft to rotationally and/or linearly actuate to move, via the frame within the first guided assembly, the set of movable cleats through the set of slits from the stowed position to the deployed position, to extend the set of movable cleats into the ground surface.

In some embodiments, in response to the determined type of the ground surface being non-granular, the controller is further configured to actuate, in a second direction, the first actuator to drive the head portion at least one guide threaded shaft to cause the threading portion of the first guide threaded shaft to rotationally and/or linearly actuate to move, via the frame within the first guided assembly, the set of movable cleats through the set of slits from the deployed position to the stowed position, to retract the set of movable cleats from the ground surface.

In some embodiments, in response to detecting, via the sensor, only one foot (e.g., single support) of the legged robot being in mechanical contact with the ground surface, the controller is configured to actuate, in the first direction, the first actuator to drive the head portion of the first guide threaded shaft to cause the threading portion of the first guide threaded shaft to rotationally and/or linearly actuate to move, via the frame within the first guided assembly, the set of movable cleats through the set of slits from the stowed position to the deployed position, to extend the set of movable cleats into the ground surface.

In some embodiments, the foot system described herein further comprises: a second set of movable cleats situated within the housing; a second guided assembly fixably coupled to the second set of movable cleats, wherein the second guided assembly is situated within the housing, and wherein the second guided assembly comprises: a second frame fixably coupled to the second set of movable cleats, a second guide threaded shaft operatively coupled to the second frame, wherein the second guide threaded shaft includes (i) a threading portion extending through the second frame within the housing and (ii) a head portion protruding the casing section, wherein the threading portion of the second guide threaded shaft is configured to rotationally and/or linearly actuate to move, via the second frame within the second guided assembly, the second set of movable cleats between the stowed position and the deployed position along the substantial portion of the housing; and a second actuator operatively coupled to the second guide threaded shaft, or the head portion thereof, wherein the second actuator is configured to drive (e.g., via a second timing belt) the head portion of the second guide threaded shaft to cause the threading portion of the second guide threaded shaft to rotationally and/or linearly actuate to move, via the second frame within the guided assembly, the second set of movable cleats through the set of slits between the stowed position and the deployed position.

In some embodiments, cleats in the set of cleats form an interdigitated pattern or a multi-angled pattern.

In some embodiments, cleats in the set of cleats are parallel to one another.

In some embodiments, the legged robot is selected from the group consisting of a one-legged robot, a bipedal robot, a tripedal robot, a quadrupedal robot, a hexapod robot, and an octopod robot.

In some embodiments, the first guided assembly comprises: a frame fixably coupled to the set of movable cleats, wherein the frame includes a rack; a pinion operatively coupled to the rack, wherein the pinion, when being driven, is configured to actuate the rack to move, via the frame within the first guided assembly, the set of movable cleats through the set of slits between the stowed position and the deployed position; and at least one actuator fixably coupled to the sole section, wherein the at least one actuator is configured to drive the pinion to actuate the rack to move, via the frame within the first guided assembly, the set of movable cleats through the set of slits between the stowed position and the deployed position along the substantial portion of the housing.

In some embodiments, the controller is configured to actuate, in a first direction, the at least one actuator to drive the pinion to actuate the rack to move, via the frame within the first guided assembly, the set of movable cleats through the set of slits from the stowed position to the deployed position, to extend the set of movable cleats into the ground surface; determine an amount of current drawn by the at least one actuator when the at least one actuator drives the pinion; and in response to the determined amount of current exceeding a predefined current threshold, yield by allowing the set of moveable cleats to move from the deployed position to the stowed position, or actuate, in a second direction, the at least one actuator to drive the pinion to actuate the rack to move, via the frame within the first guided assembly, the set of movable cleats through the set of slits from the deployed position to the stowed position, to retract the set of movable cleats from the ground surface.

In some embodiments, the foot system described herein further comprises: a sensor (e.g., camera) situated within the housing, wherein the sensor is configured to capture an image of the ground surface, and wherein the controller is configured to: receive, via the sensor, the captured image of the ground surface; determine, via a detection algorithm or a trained AI model, type of the ground surface using the received captured image at every predefined period of time (e.g., every 1 second); and actuate the at least one actuator to drive the pinion to actuate the rack to move, via the frame within the first guided assembly, the set of movable cleats through the set of slits, based on the determined type of the ground surface.

In some embodiments, in response to the determined type of the ground surface being granular, the controller is further configured to: actuate, in a first direction, the at least one actuator to drive the pinion to actuate the rack to move, via the frame within the first guided assembly, the set of movable cleats through the set of slits from the stowed position to the deployed position, to extend the set of movable cleats into the ground surface.

In some embodiments, in response to the determined type of the ground surface being non-granular, the controller is further configured to: actuate, in a second direction, the at least one actuator to drive the pinion to actuate the rack to move, via the frame within the first guided assembly, the set of movable cleats through the set of slits from the deployed position to the stowed position, to retract the set of movable cleats from the ground surface.

In another aspect, a legged robot is disclosed comprising: a foot system for a legged robot including: a set of movable cleats coupled to at least one guided assembly, or a portion thereof; a sole section having a set of slits, wherein the sole section is configured to be in mechanical contact with a ground surface including soft soil or hard soil; a casing section fixably coupled to the sole section to form a housing to encapsulate the set of movable cleats and the at least one guided assembly, or a portion thereof; and a controller configured to direct an actuator located in the casing section to move the set of movable cleats through the set of slits between a stowed position distal to the sole section and a deployed position proximal to the sole section along a substantial portion of the housing.

In some embodiments, the at least one guided assembly is configured to (i) move the set of movable cleats through the set of slits from the stowed position to the deployed position, to extend the set of movable cleats into the ground surface; and (ii) move the set of movable cleats through the set of slits from the deployed position to the stowed position, to retract the set of movable cleats from the ground surface.

In some embodiments, the at least one guided assembly comprises: a frame fixably coupled to the set of movable cleats; and at least one guide threaded shaft operatively coupled to the frame, wherein the at least one guide threaded shaft includes (i) a threading portion extending through the frame within the housing and (ii) a head portion protruding the casing section, wherein the threading portion is configured to rotationally and/or linearly actuate to move, via the frame, the set of movable cleats through the set of slits between the stowed position and the deployed position.

In some embodiments, the foot system further comprises: at least one actuator operatively coupled to the at least one guide threaded shaft, or the head portion thereof, wherein the at least one actuator is configured to drive the head portion of the at least one guide threaded shaft to cause the threading portion of the at least one guide threaded shaft to rotationally and/or linearly actuate to move, via the frame, the set of movable cleats through the set of slits between the stowed position and the deployed position; and a sensor situated within the housing, wherein the sensor is configured to capture an image of the ground surface, and wherein the controller is configured to: receive, via the sensor, the captured image of the ground surface; determine, via a detection algorithm or a trained AI model, type of the ground surface using the received captured image at every predefined period of time; and actuate the at least one actuator to drive the head portion of the at least one guide threaded shaft, based on the determined type of the ground surface.

### BRIEF DESCRIPTION OF DRAWINGS

FIGS. 1A, 1B, 1C, 1D, 1E, 1F, and 1G each show an example foot system for facilitating movements of a legged robot across various terrains, including soft and hard surfaces, using movable/retractable cleats, in accordance with an illustrative embodiment.

FIGS. 2A, 2B, 2C, and 2D each show an example formation of cleats in the set of movable cleats, in accordance with an illustrative embodiment.

FIGS. 3A, 3B, 3C, 3D, 3E, 3F, 3G, 3H, and 3I each shows an example iterative method for operating a controller of the exemplary system, in accordance with an illustrative embodiment.

FIGS. 4A and 4B show a first fabricated foot system that includes a set of movable cleats, a camera, an actuator, a timing belt, a single guided assembly comprising a frame and guide threaded shafts, and a housing encapsulating the movable cleats, the camera, and the single guided assembly, as described in relation to FIG. 1D.

FIG. 4C shows a bipedal robot moving across a ground surface with soft soil using the first fabricated foot system.

FIGS. 4D, 4E, 4F, and 4G each show components in the first fabricated foot system.

FIGS. 5A and 5B each show a second fabricated foot system that includes a set of movable cleats, a camera, an actuator, a pinion, and a guided assembly having a frame with a rack, as described in relation to FIG. 1G.

FIG. 5C shows a bipedal robot moving across a ground surface using the second fabricated foot system.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

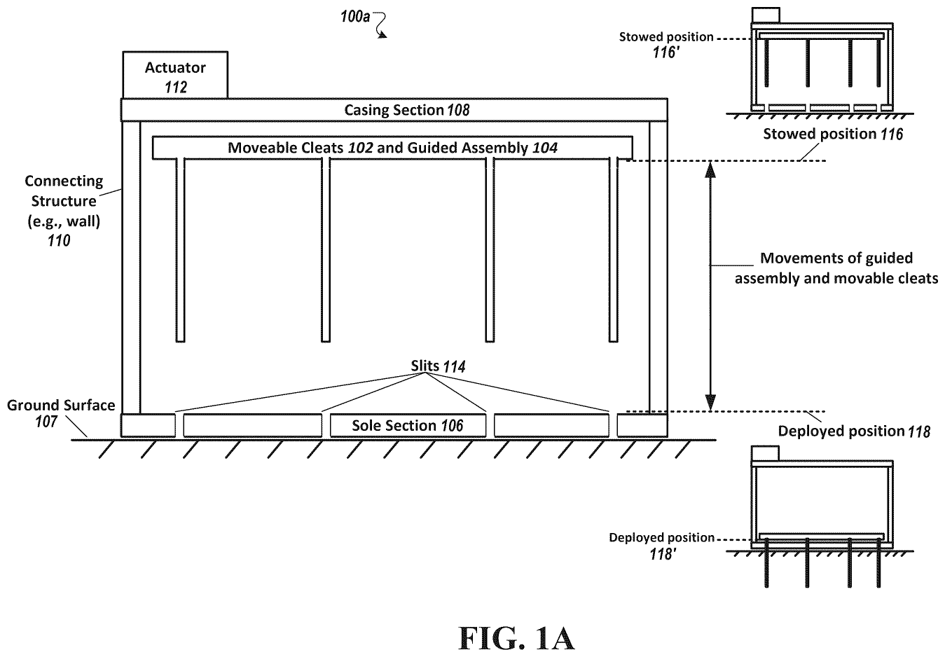

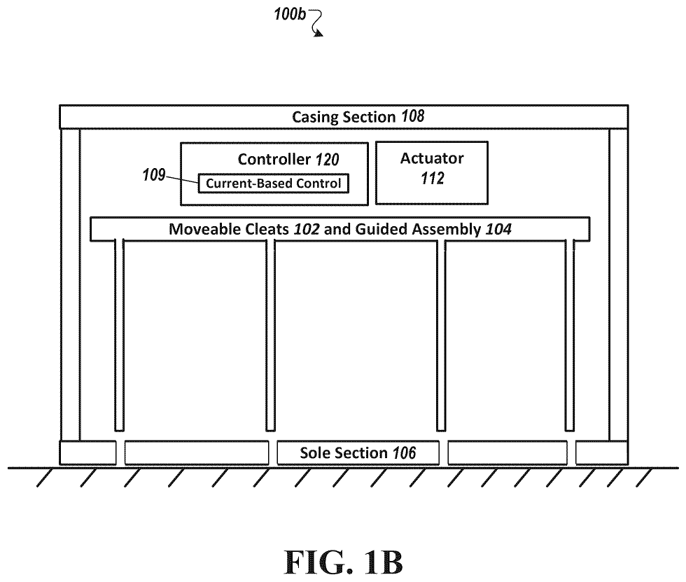

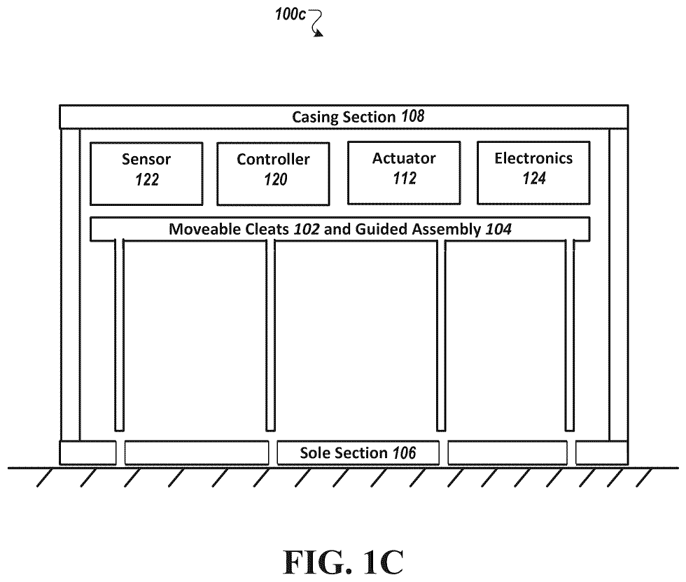

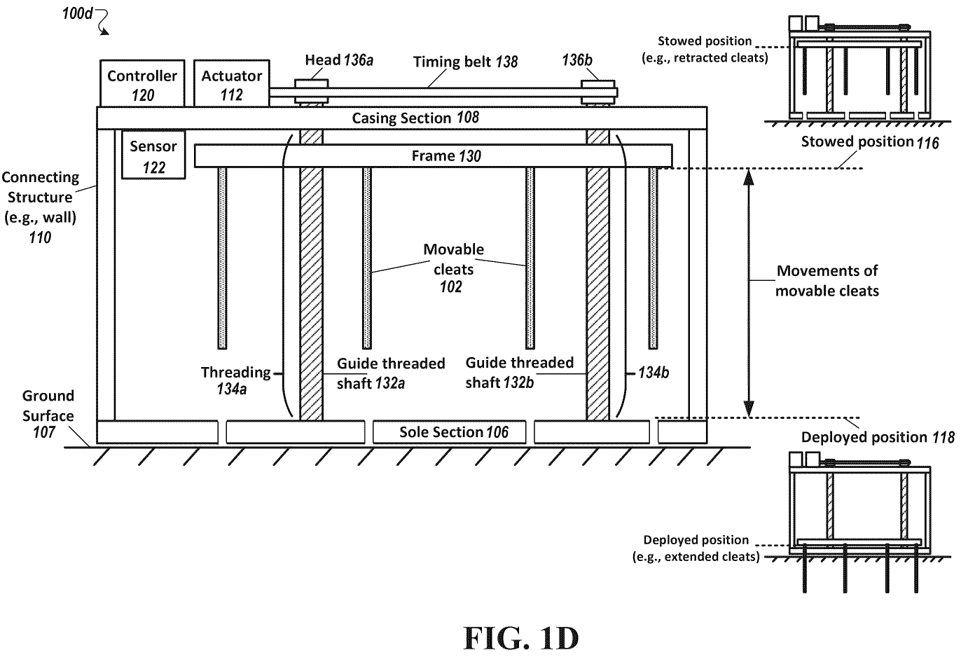

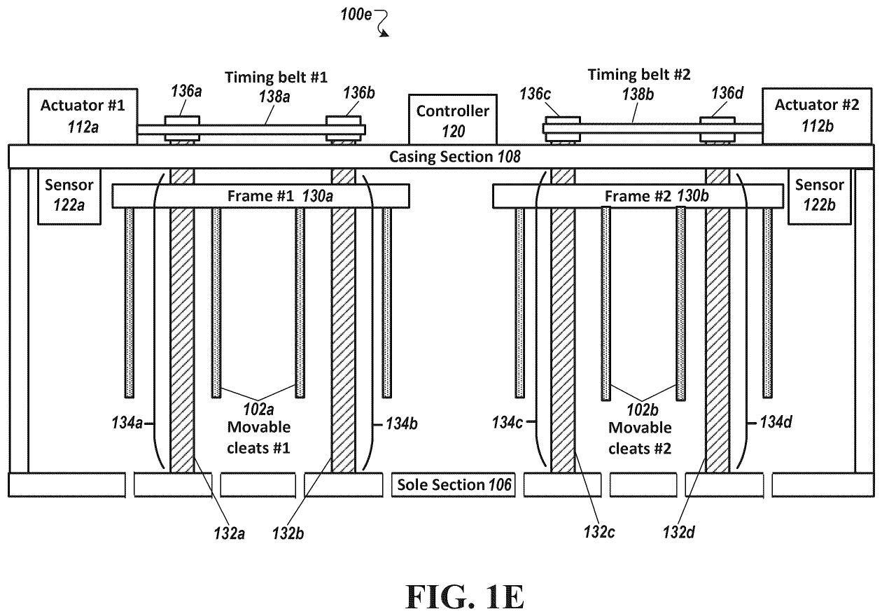

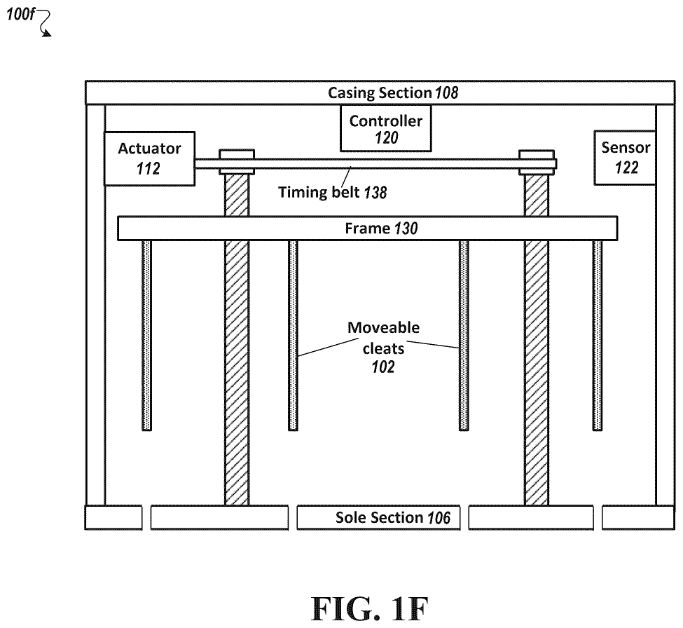

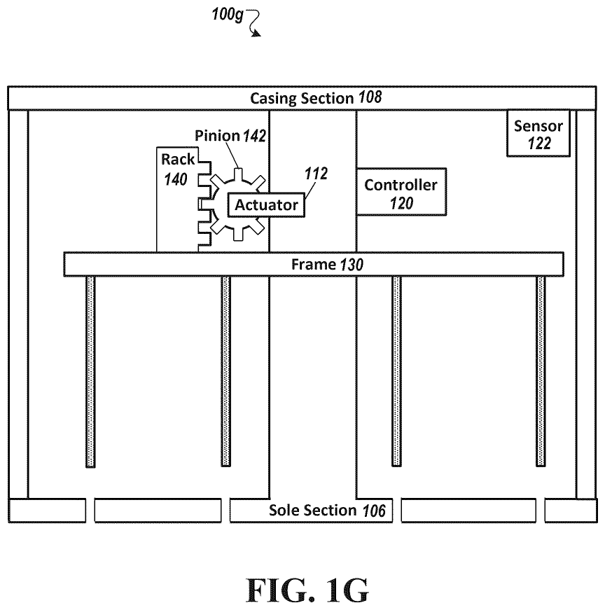

FIGS. 1A-1G each show an example foot system 100 (e.g., 100a, 100b, 100c, 100d, 100e, 100f, 100g) for facilitating movements of a legged robot across various terrains, including soft (e.g., snow, sand) and hard surfaces (e.g., concrete), using movable/retractable cleats, in accordance with an illustrative embodiment. The legged robot can be one-legged, bipedal, tripedal, quadrupedal, hexapod, or octopod.

In the examples shown in FIGS. 1A-1G, the exemplary system 100 (e.g., 100a, 100b, 100c, 100d, 100e, 100f, 100g) includes at least one set of movable cleats 102 (e.g., blades, films), at least one guided assembly 104, a sole section 106, a casing section 108, and at least one actuator 112. The set of movable cleats 102 is coupled to the guided assembly 104, or a portion thereof (e.g., a frame 130). The sole section 106 is configured to be in mechanical contact with a ground surface 107, which can include soft or hard soil. The sole section 106 includes a set of slits 114, in which each slit is configured to fit with a respective cleat in the set of movable cleats 102. The slit 114 may include a flap to reduce or prevent contaminants from entering the internal space of the system. The casing section 108 is fixably coupled, via a connecting structure 110 (e.g., wall), to the sole section 106 to form a housing that encapsulates the set of movable cleats 102 and the guided assembly 104. In some embodiments, the housing further encapsulates the actuator 112 (see FIGS. 1F-1G). In some embodiments, the actuator 112 is located outside the housing (see FIGS. 1D-1E).

The actuator 112, when being directed (e.g., by a controller), is configured to move, via the guided assembly 104 or components thereof (e.g., a frame 130, a guide threaded shaft 132, a rack 140, a pinion 142), the set of movable cleats 102 through the set of slits 114 between (i) a stowed position 116 (shown as 116′) distal to the sole section 106 and (ii) a fully deployed position 118 (shown as 118′) and positions between the stowed position 116 and the sole, section 106 along a substantial portion of the housing. The set of movable cleats 102 extends into the ground surface 107 when moved, by the actuator 112 via the guided assembly 104, through the set of slits 114 from the stowed position 116 to the deployed position 118. The set of movable cleats 102 retracts from the ground surface 107 when moved, by the actuator 112 via the guided assembly 104, through the set of slits 114 from the deployed position 118 to the stowed position 116.

In some embodiments, the actuator 112 is an electric actuator selected from the group consisting of a DC motor, an AC motor, a geared motor, a stepper motor, a servo motor, a solenoid, an electrostatic motor, and a piezoelectric motor.

In some embodiments, the casing section 108 includes a mounting component (e.g., a joint) configured to mount the exemplary system to a leg of the legged robot.

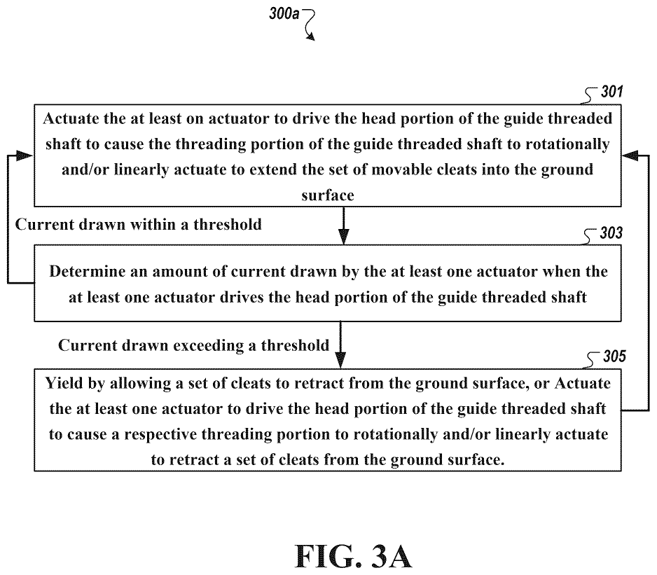

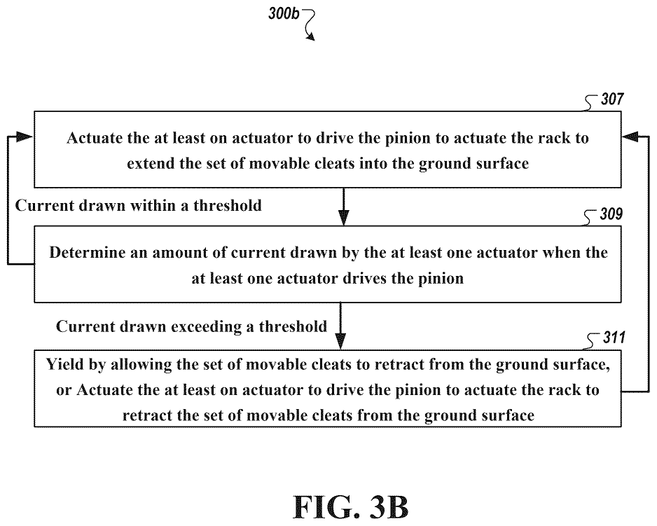

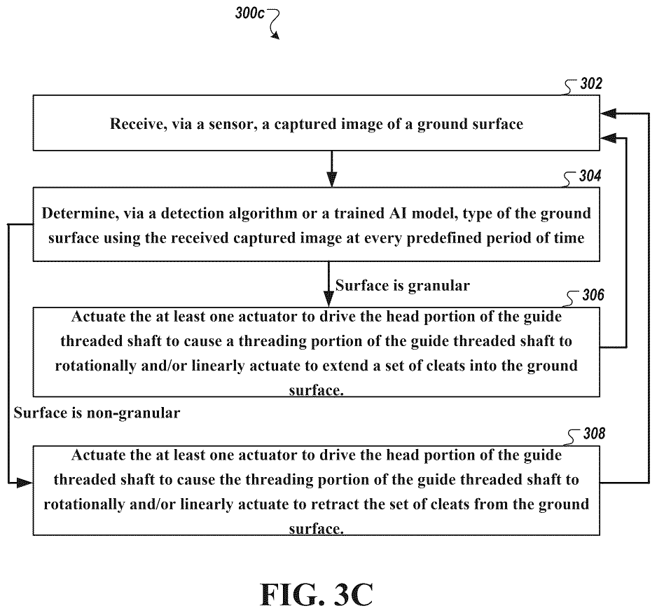

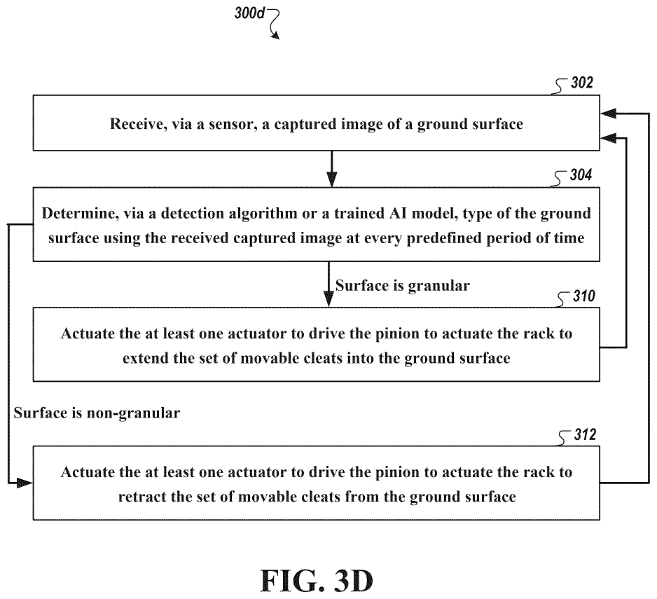

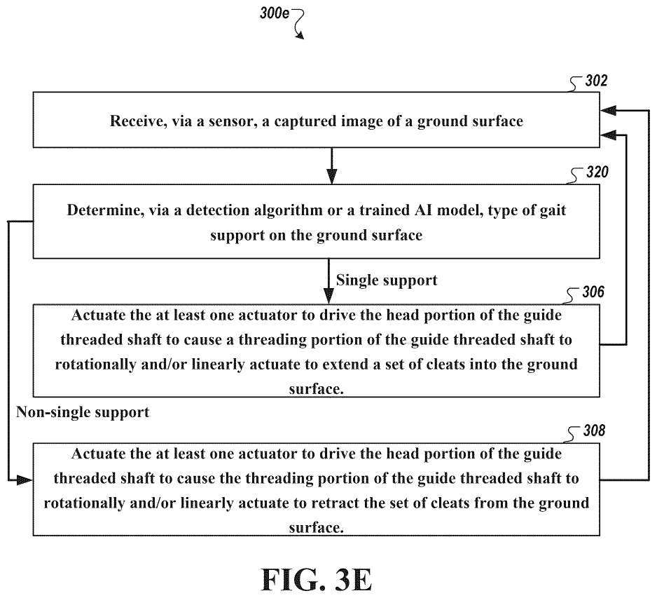

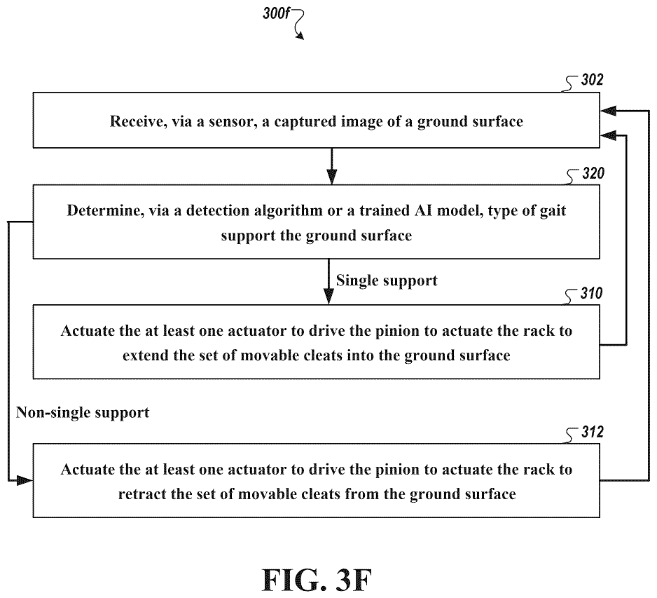

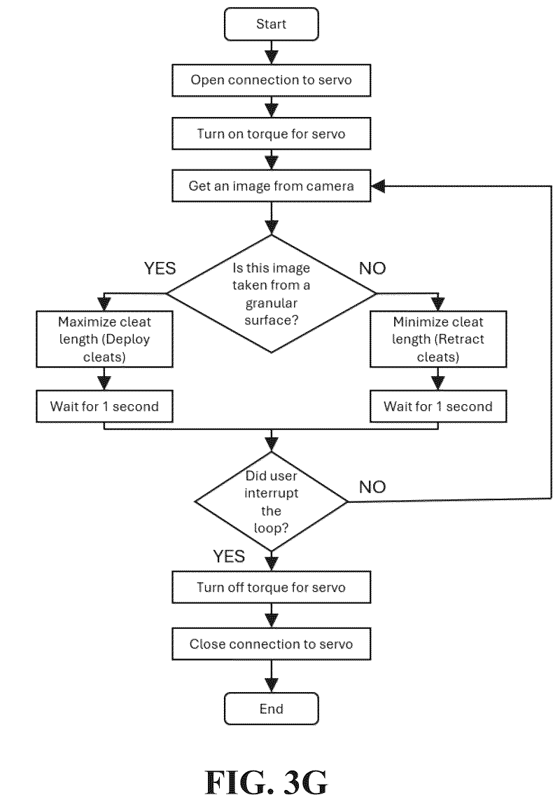

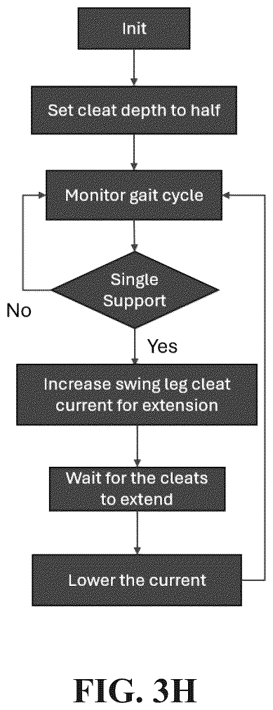

In some embodiments, the exemplary system 100 (e.g., 100b) further includes at least one controller 120 located inside or outside the housing, where the controller 120 is configured with a current-based control 109. In some embodiments, the controller 120 is configured to (i) determine, via the current-based control 109, the amount of current drawn by the actuator 112 as the actuator 112 moves the set of movable cleats 102, and (ii) yield by allowing the set of moveable cleats 102 to move, or drive the actuator 112 to move, via the guided assembly 104 or components thereof, the set of movable cleats 102 based on the determined amount of current, as described in FIGS. 3A-3B.

In some embodiments, the controller 120 is configured to yield its control of the actuator 112 to allow passive retraction of the set of movable cleats 102 when an external force acting on the set of movable cleats 102 exceeds the torque generated by the actuator 112 at a predefined current threshold, such that the set of movable cleats 102 are forced back (e.g., retract) into the housing without receiving a control signal from the controller 120, and subsequently extend when the external force is removed. The external force can include a ground reaction force generated when the exemplary system 100 is in contact with the ground surface 107, and the external force is removed when the exemplary system 100 is no longer in contact with the ground surface 107.

In some embodiments, the exemplary system 100 (e.g., 100c, 100d, 100e, 100f, 100g) further includes at least one controller 102, at least one sensor 122, and additional electronics 124. The controller 120, located inside or outside the housing, is configured to drive the actuator 112 to move, via the guided assembly 104 or components thereof, the set of movable cleats 102 between the stowed position 116 and the deployed position 118. The sensor 122, located within the housing, is configured to capture an image of the ground surface 107 and transmit the captured image to the controller 120. The additional electronics 124 can include wires, memory boards, and any electrical components that support the operation of the movable cleats 102, the guided assembly 104, the actuator 112, the controller 120, and the sensor 122.

In some embodiments, the controller 120 is configured to (i) determine the type of the surface 107 or of the gait support (e.g., of the legged robot) on the surface 107 using the captured image, and (ii) drive the actuator 112 to move, via the guided assembly 104 or components thereof, the set of movable cleats 102 based on the determination, as described in FIGS. 3C-3G.

In some embodiments, the sensor 122 is selected from the group consisting of an optical imaging sensor (e.g., camera), an infrared imaging sensor (e.g., long-wave infrared, short-wave infrared), and a profilometric sensor (e.g., white-light interferometer).

Single Guided Assembly. In the examples shown in FIGS. 1D and 1F, the exemplary system 100 (e.g., 100d, 100f) includes a single guided assembly 104 that includes at least one frame 130 and at least one guide threaded shaft 132 (e.g., a leadscrew), such as 132a and 132b. The frame 130 is fixably coupled to the set of movable cleats 102. Each guide threaded shaft 132a and 132b includes (i) a respective threading portion 134a and 134b extending through the frame 130 within the housing and (ii) a respective head portion 136a and 136b protruding from the casing section 108. Each threading portion 134a and 134b is configured to rotationally and/or linearly actuate to move, via the frame 130, the set of movable cleats 102 through the set of slits 114 between the stowed position 116 and the deployed position 118.

The head portions 136a and 136b of the respective guide threaded shafts 132a and 132b are operatively coupled to the actuator 112 via a timing belt 138. When directed by the controller 120, the actuator 112 can drive, via the timing belt 138, the head portions 136a and 136b of the threaded shafts 132 and 132b to cause the respective threading portions 134a and 134b to rotationally and/or linearly actuate to move, via the frame 130, the set of movable cleats 102 through the set of slits 114 between the stowed position 116 and the deployed position 118.

Multiple Threaded Shaft Guided Assemblies. In the example shown in FIG. 1E, the exemplary system 100e includes two sets of movable cleats 102a and 102b (shown as movable cleats #1 and movable cleats #2), two guided assemblies 104, two actuators 112a and 112b (shown as actuator #1 and actuator #2), and two sensors 122a and 122b. Each guided assembly 104 includes (i) a respective frame 130a (shown as frame #1) and 130b (shown as frame #2), and (ii) two respective guide threaded shafts 132a-132b and 132c-132d. Each frame 130a and 130b, within the respective guided assembly, is fixably coupled to the respective set of movable cleats 102a and 102b.

Every two guide threaded shafts 132a-132b and 132c-132d, within the respective guided assembly, include (i) two respective threading portions 134a-134b and 134c-134d extending through the respective frame 130a and 130b and (ii) two respective head portions 136a-136b and 136c-136d protruding from the casing section 108. Every two threading portions 134a-134b and 134c-134d are configured to rotationally and/or linearly actuate to move, via the respective frame 130a and 130b, the respective set of movable cleats 102 and 102b through the set of slits 114 between the stowed position 116 and the deployed position 118.

Every two head portions 136a-136b and 136c-136d are operatively coupled to the respective actuator 112a and 112b via a respective timing belt 138a and 138b. When directed by the controller 120, the actuator 112a and 112b can drive, via the respective timing belt 138a and 138b, the two respective head portions 136a-136b and 136c-136d to cause the two respective threading portions 134a-134b and 134c-134d to rotationally and/or linearly actuate to move, via the respective frame 130a and 130b, the respective set of movable cleats 102a and 102b through the set of slits 114 between the stowed position 116 and the deployed position 118.

Rack-and-Pinion Guided Assembly. In the example shown in FIG. 1G, the exemplary system 100g includes a guided assembly 104 having the frame 130 and a pinion 142. The frame 130 includes a rack 140 operatively coupled to the pinion 142. The pinion 142, when driven by the actuator 112, is configured to actuate the rack 140 to move, via the frame 130, the set of movable cleats 102 through the set of slits 114 between the stowed position 116 and the deployed position 116, along the substantial portion of the housing. In some embodiments, the actuator 112 is fixably coupled to the sole section 106.

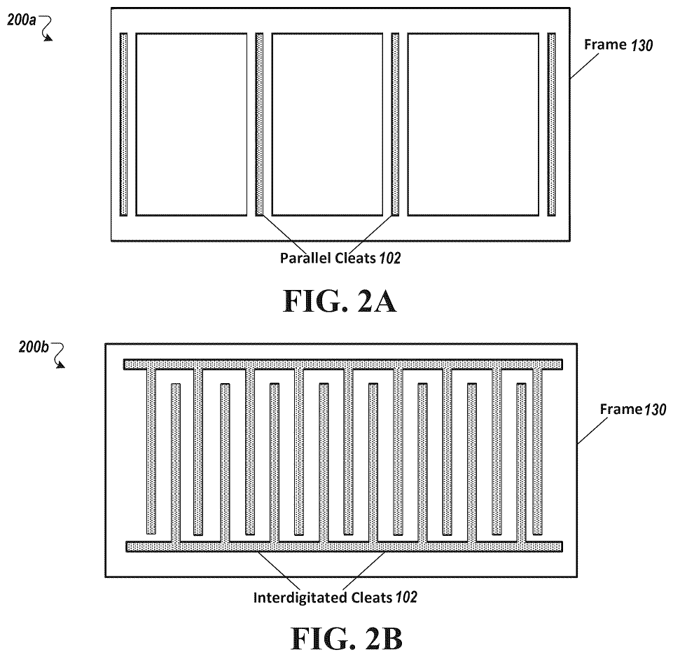

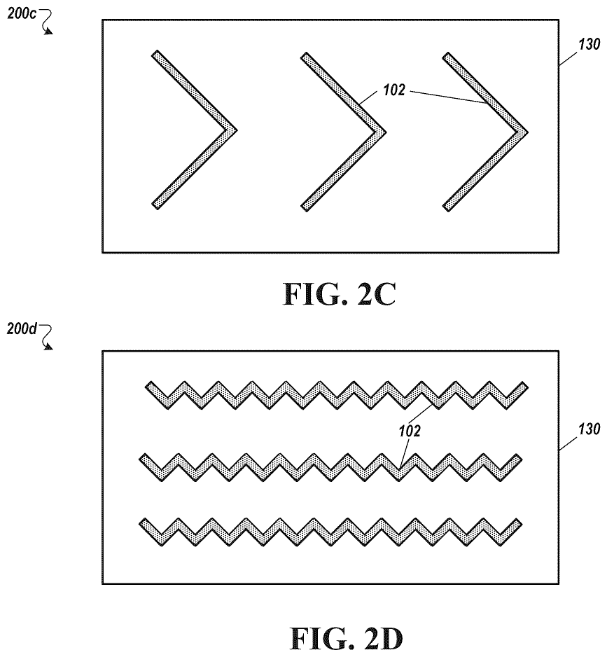

Movable Cleats Formation. FIG. 2A-2D each show an example formation of cleats in the set of movable cleats 102 operatively coupled to the frame 130, in accordance with an illustrative embodiment. In FIG. 2A, cleats in the set of movable cleats 102 are parallel to one another. In FIG. 2B, cleats in the set of movable cleats 102 form interdigitated patterns 200b. In FIGS. 2C-2D, cleats in the set of movable cleats 102 form single-angled patterns 200c or multi-angled patterns 200d, respectively.

### Example Method

FIGS. 3A-3G each show an example iterative method for operating the controller (e.g., 120) of the exemplary system, in accordance with an illustrative embodiment. The iterative methods 300a and 300b of FIGS. 3A and 3B are implemented when the exemplary system is configured without any sensors (see FIG. 1B). The iterative methods 300c and 300e of FIGS. 3C and 3E are implemented when the exemplary system is configured with one or more cylindrical guided assemblies (see FIGS. 1D-1F). The iterative methods 300d and 300f of FIGS. 3D and 3F are implemented when the exemplary system is configured with a rack-and-pinion guided assembly (see FIG. 1G).

Current-Based Operating Method (300a, 300b). In the methods 300a-300b of FIGS. 3A-3B, the controller (e.g., 120) is configured to (i) determine the amount of current drawn by the at least one actuator (e.g., 112) as the at least one actuator (e.g., 112) moves the set of movable cleats (e.g., 102), and (ii) yield by allowing the set of movable cleats to move, or drive the at least one actuator (e.g., 112) to move the set of movable cleats (e.g., 102) based on the determined amount of current.

In the method 300a of FIG. 3A, at step 301, the controller (e.g., 120) is configured to actuate the at least one actuator (e.g., 112) to drive the head portions (e.g., 136) of the respective threaded shafts (e.g., 132) to cause the respective threading portions (e.g., 134) to rotationally and/or linearly actuate to move, via the frame (e.g., 130), the set of movable cleats (e.g., 102) from the stowed position (e.g., 116) to the deployed position (e.g., 118), extending the set of movable cleats (e.g., 102) into the ground surface (e.g., 107). At step 303, the controller (e.g., 120) is configured to determine an amount of current drawn by the at least one actuator (e.g., 112) when the at least one actuator (e.g., 112) drives the head portions of the respective guide threaded shafts (e.g., 132).

At step 305, when the determined amount of current exceeds a predefined current threshold, the controller (e.g., 120) is configured to (i) yield by allowing the set of movable cleats (e.g., 102) to move from the deployed position (e.g., 118) to the stowed position (e.g., 116), or (ii) actuate the at least one actuator (e.g., 112) to drive the head portions (e.g., 136) of the respective threaded shafts (e.g., 132) to cause the respective threading portions (e.g., 134) to rotationally and/or linearly actuate to move, via the frame (e.g., 130), the set of movable cleats (e.g., 102) from the deployed position (e.g., 118) to the stowed position (e.g., 116), retracting the set of movable cleats (e.g., 102) from the ground surface (e.g., 107).

When the determined amount of current is within the predefined current threshold, or after the step 305, the method 300a repeats by returning to step 301, at which the controller (e.g., 120) is configured to actuate the at least one actuator (e.g., 112) to drive the head portions (e.g., 136) of the respective threaded shafts (e.g., 132) to cause the respective threading portions (e.g., 134) to rotationally and/or linearly actuate to extend the set of movable cleats (e.g., 102) into the ground surface (e.g., 107).

In the method 300b of FIG. 3B, at step 307, the controller (e.g., 120) is configured to actuate the at least one actuator (e.g., 112) to drive the pinion (e.g., 142) to actuate the rack (e.g., 140) to move, via the frame (e.g., 130), the set of movable cleats (e.g., 102) from the stowed position (e.g., 116) to the deployed position (e.g., 118), extending the set of movable cleats (e.g., 102) into the ground surface (e.g., 107). At step 309, the controller (e.g., 120) is configured to determine an amount of current drawn by the at least one actuator (e.g., 112) when the at least one actuator drives the pinion (e.g., 142).

At step 311, when the determined amount of current exceeds a predefined current threshold, the controller (e.g., 120) is configured to (i) yield by allowing the set of movable cleats to move from the deployed position (e.g., 118) to the stowed position (e.g., 116), or (ii) actuate the at least one actuator (e.g., 112) to drive the pinion (e.g., 142) to actuate the rack (e.g., 140) to move, via the frame (e.g., 130), the set of movable cleats (e.g., 102) from the deployed position (e.g., 118) to the stowed position (e.g., 116), retracting the set of movable cleats (e.g., 102) from the ground surface (e.g., 107).

When the determined amount of current is within the predefined current threshold, or after the step 311, the method 300b repeats by returning to step 307, at which the controller (e.g., 120) is configured to actuate the at least one actuator (e.g., 112) to drive the pinion (e.g., 142) to actuate the rack (e.g., 140) to extend the set of movable cleats (e.g., 102) into the ground surface (e.g., 107).

Surface-Based Operating Method (300c, 300d). In the methods 300c-300d of FIGS. 3C-3D, the controller (e.g., 120) is configured to (i) monitor the ground surface (e.g., 107) and (ii) actuate the at least one actuator (e.g., 112) based on the type of the ground surface (e.g., 107). At step 302, the controller (e.g., 120) is configured to receive, via the sensor (e.g., 122), a captured image of the ground surface (e.g., 107). At step 304, the controller (e.g., 120) is configured to determine, via a detection algorithm or a trained AI model, the type of the ground surface (e.g., 107) using the received captured image at every predefined period of time (e.g., every 1 second).

In the method 300c of FIG. 3C, at step 306, when the ground surface (e.g., 107) is granular (e.g., sand, snow), the controller (e.g., 120) is configured to actuate the at least one actuator (e.g., 112) to drive the head portions (e.g., 136) of the respective guide threaded shafts (e.g., 132), to cause the respective threading portions (e.g., 134) to rotationally and/or linearly actuate to move, via the respective frame (e.g., 130), the set of movable cleats (e.g., 102) from the stowed position (e.g., 116) to the deployed position (e.g., 118), extending the set of movable cleats (e.g., 102) into the ground surface (e.g., 107). At step 308, when the ground surface (e.g., 107) is non-granular (e.g., rigid, concrete), the controller (e.g., 120) is configured to actuate the at least one actuator (e.g., 112) to drive the head portions (e.g., 136) of the respective guide threaded shafts (e.g., 132), to cause the respective threading portions (e.g., 134) to rotationally and/or linearly actuate to move, via the respective frame (e.g., 130), the set of movable cleats (e.g., 102) from the deployed position (e.g., 118) to the stowed position (e.g., 116), retracting the set of movable cleats (e.g., 102) from the ground surface (e.g., 107). After the steps 306 or 308, the method 300c repeats by returning to step 302, at which the controller (e.g., 120) is configured to receive, via the sensor (e.g., 122), the captured image of the ground surface (e.g., 107).

In the method 300d of FIG. 3D, at step 310, when the ground surface (e.g., 107) is granular (e.g., sand, snow), the controller (e.g., 120) is configured to actuate the at least one actuator (e.g. 112) to drive the pinion (e.g., 142), to actuate the rack (e.g., 140) to move, via the frame (e.g., 130), the set of movable cleats (e.g., 102) from the stowed position (e.g., 116) to the deployed position (e.g., 118), extending the set of movable cleats (e.g., 102) into the ground surface (e.g., 107). At step 312, when the ground surface (e.g., 107) is non-granular (e.g., rigid, concrete), the controller (e.g., 120) is configured to actuate the at least one actuator (e.g. 112) to drive the pinion (e.g., 142), to actuate the rack (e.g., 140) to move, via the frame (e.g., 130), the set of movable cleats (e.g., 102) from the deployed position (e.g., 118) to the stowed position (e.g., 116), retracting the set of movable cleats (e.g., 102) from the ground surface (e.g., 107). After the steps 310 or 312, the method 300d repeats by returning to step 302, at which the controller (e.g., 120) is configured to receive, via the sensor (e.g., 122), the captured image of the ground surface (e.g., 107).

Single-Support-Based Operating Method (300e, 300f). In the methods 300e-300f of FIGS. 3E-3F, the controller (e.g., 120) is configured to (i) monitor the gait support (e.g., of a legged robot) on the ground surface (e.g., 107) and (ii) actuate the actuator (e.g., 112) based on the type of gait support (e.g., single support). At step 302, the controller (e.g., 120) is configured to receive, via the sensor (e.g., 122), a captured image of the ground surface (e.g., 107). At step 320, the controller (e.g., 120) is configured to determine, via a detection algorithm or a trained AI model, the type of gait support using the received captured image at every predefined period of time (e.g., every 1 second). In some embodiments, the type of gait support is determined by the number of feet (e.g., of a legged robot) in mechanical contact with the ground surface (e.g., 107).

In the method 300e of FIG. 3E, at step 306, when the gait support is single (e.g., only one foot in mechanical contact with the surface), the controller (e.g., 102) is configured to actuate the at least one actuator (e.g., 112) to drive the head portions (e.g., 136) of the respective guide threaded shafts (e.g., 132), to cause the respective threading portions (e.g., 134) to rotationally and/or linearly actuate to move, via the respective frame (e.g., 130), the set of movable cleats (e.g., 102) from the stowed position (e.g., 116) to the deployed position (e.g., 118), extending the set of movable cleats (e.g., 102) into the ground surface (e.g., 107). At step 308, when the gait support is non-single (e.g., two or more feet in mechanical contact with the surface), the controller (e.g., 120) is configured to actuate the at least one actuator (e.g., 112) to drive the head portions (e.g., 136) of the respective guide threaded shafts (e.g., 132), to cause the respective threading portions (e.g., 134) to rotationally and/or linearly actuate to move, via the respective frame (e.g., 130), the set of movable cleats (e.g., 102) from the deployed position (e.g., 118) to the stowed position (e.g., 116), retracting the set of movable cleats (e.g., 102) from the ground surface (e.g., 107). After the steps 306 or 308, the method 300e repeats by returning to step 302, at which the controller (e.g., 120) is configured to receive, via the sensor (e.g., 122), the captured image of the ground surface (e.g., 107).

In the method 300f of FIG. 3F, at step 310, when the gait support is single (e.g., only one foot in mechanical contact with the surface), the controller (e.g., 120) is configured to actuate the at least one actuator (e.g. 112) to drive the pinion (e.g., 142), to actuate the rack (e.g., 140) to move, via the frame (e.g., 130), the set of movable cleats (e.g., 102) from the stowed position (e.g., 116) to the deployed position (e.g., 118), extending the set of movable cleats (e.g., 102) into the ground surface (e.g., 107). At step 312, when the gait support is non-single (e.g., two or more feet in mechanical contact with the surface), the controller (e.g., 120) is configured to actuate the at least one actuator (e.g. 112) to drive the pinion (e.g., 142), to actuate the rack (e.g., 140) to move, via the frame (e.g., 130), the set of movable cleats (e.g., 102) from the deployed position (e.g., 118) to the stowed position (e.g., 116), retracting the set of movable cleats (e.g., 102) from the ground surface (e.g., 107). After the steps 310 or 312, the method 300f repeats by returning to step 302, at which the controller (e.g., 120) is configured to receive, via the sensor (e.g., 122), the captured image of the ground surface (e.g., 107).

FIGS. 3G-3I each shows an example flowchart having an algorithmic state machine, e.g., for the exemplary system, in accordance with an illustrative embodiment. The state machine in FIG. 3G can be implemented for the controller (e.g., 120) that employs the surface-based operating method (e.g., 300c, 300d). The state machine in FIG. 3H can be implemented for the controller (e.g., 120) that employs the single-support-based operating method (e.g., 300e, 300f). The state machine in FIG. 3I can be implemented for the controller (e.g., 120) that employs the current-based operating method (e.g., 300a, 300b).

### Example Artificial Intelligence (AI) and Machine Learning (ML) Models

Machine Learning. In addition to the machine learning features described above, the exemplary system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include, but are not limited to, artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes'(NB) classifier is a supervised classification model that is based on Bayes'Theorem, which assumes independence among features (i.e., the presence of one feature in a class is unrelated to the presence of any other features). NB classifiers are trained with a data set by computing the conditional probability distribution of each feature given a label and applying Bayes'Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Result and Additional Examples

A study was conducted to fabricate two-foot systems for facilitating the movements of a legged robot across various terrains, using movable/retractable cleats. The first fabricated foot system included a set of movable cleats, a camera, an actuator, a timing belt, a single guided assembly comprising a frame and guide threaded shafts (e.g., leadscrews), and a housing encapsulating the movable cleats, the camera, and the single guided assembly, as described in relation to FIG. 1D. The second fabricated foot system included a set of movable cleats, a camera, an actuator, a pinion, and a guided assembly having a frame with a rack, as described in relation to FIG. 1G.

In one implementation, the foot system comprises two primary components: the base component and the cleated component. In one embodiment, the exemplary system employs a rack-and-pinion mechanism (RP). In another embodiment, the exemplary system employs a timing belt mechanism (TB). Housing member. The exemplary systems each employ a housing member (i.e., structural frame) configured to attach to a robot's ankle joint, operating as a flat foot with holes positioned on a surface to facilitate the movement of the cleated component for both RP and TB mechanisms. The housing member can house a rotary motor fixed to its structure for RP and TB mechanisms. The motor shaft houses a pinion for the RP mechanism, whereas the motor is connected to a timing belt with a gear for the TB mechanism. In the RP mechanism, the housing member comprises of a single part. In the TB mechanism, the housing member comprises of multiple parts.

Cleated component. The cleated component comprises thin, vertical blades (cleats) configured to move vertically through the holes of the base component for both RP and TB mechanisms. In the RP embodiment, the cleated component can incorporate a vertical rack extending from the housing member that interacts with the motor's pinion to facilitate precise linear motion. The cleated component is connected to the housing member via a linear bearing that can minimize friction and stabilize the movement, providing precise and repeatable adjustments of the cleat position.

In the TB embodiment, the cleated component houses leadscrews that can go through the threaded holes. The cleated component can move vertically as the leadscrews rotate, which can be driven by the timing belt to facilitate vertical motion. The bearings hold the leadscrews in place, reducing friction and facilitating smooth, precise actuation as the cleated component moves.

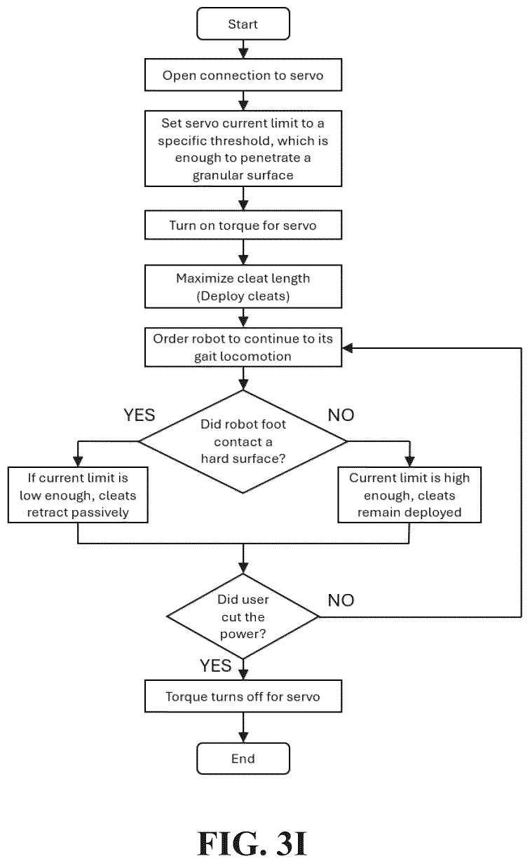

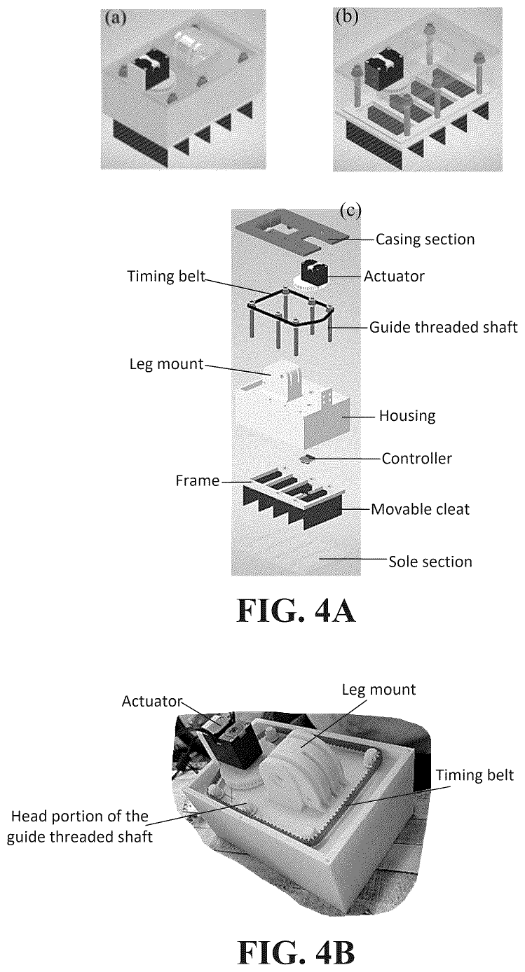

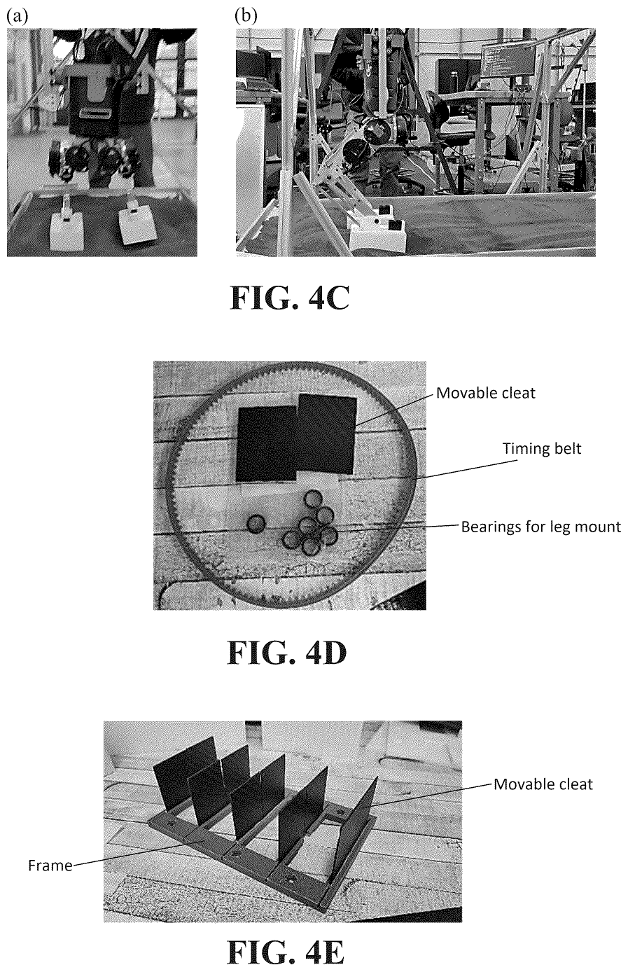

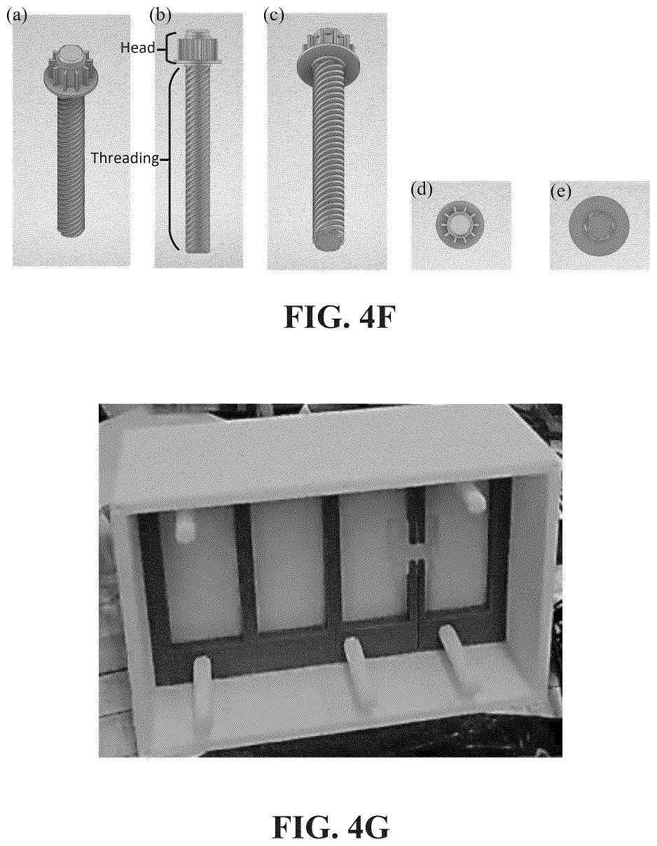

FIG. 4A shows a three-dimensional (3D)-rendered model for the first fabricated foot system and associated components. FIG. 4B shows the fabricated foot system in the study.

FIG. 4C shows a bipedal robot moving across a ground surface with soft soil using the first fabricated foot system. As shown, the first fabricated foot system is mounted to the leg of the robot.

FIG. 4D shows the movable cleats, the timing belt, and the mount bearings in the first fabricated foot system. The bearings are configured to facilitate mounting the first fabricated foot system to the leg of the bipedal robot.

FIG. 4E shows the frame and the set of movable cleats in the first fabricated foot system, in which the set of movable cleats is fixably coupled to the frame.

FIG. 4F shows a leadscrew used as one of the guide threaded shafts in the first fabricated foot system. As shown, the leadscrew includes a threading portion and a head portion.

FIG. 4G shows the housing in the first fabricated foot system that encapsulates the guide threaded shafts and the frame.

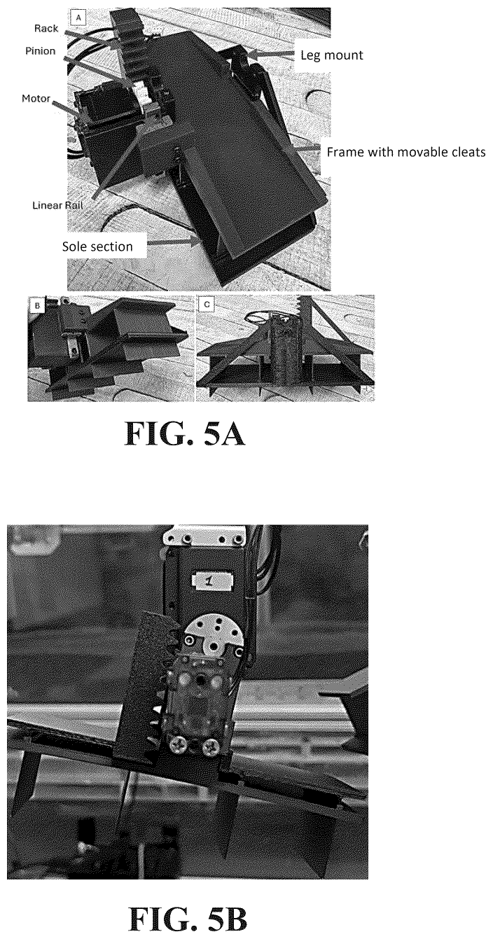

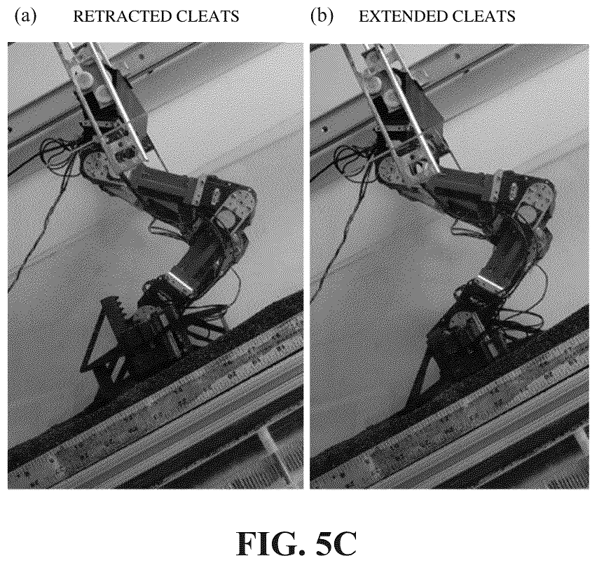

FIGS. 5A-5B each show the second fabricated foot system in the study. FIG. 5C shows a bipedal robot moving across a ground surface using the second fabricated foot system. As shown, the second fabricated foot system is mounted to the leg of the robot.

### Discussion

Current state-of-the-art foot systems have been developed for robotic platforms guided by speed, stability, and reliability objectives [1], [2], focusing on actuating multi-segmented foot mechanisms designed for the robot's interaction with rigid surfaces. The current state-of-the-art foot systems either (i) feature extensions that protrude passively from the shoe sole [3], [4] or (ii) introduce a transformable shoe equipped with sensors and actuators that adapt to various terrains [5]. No actuated robotic foot system has been developed to control and manipulate the flow and deformation of soft surfaces (e.g., sand, snow) to enhance locomotion. Compared to the current state-of-the-art foot systems, the exemplary foot system can regulate and manipulate the flow and deformation of soft, flowable surfaces (e.g., sandy, snowy slopes) via the motor control of cleat length that extends from the foot sole, providing seamless transitions between rigid and soft, penetrable terrains.

In addition, current state-of-the-art robotic foot designs are often engineered for rigid surfaces and often fail locomotion on deformable and flowable surfaces. While some robotic foot designs exist for granular surfaces, they lack adaptability for diverse terrains and seamless transitions between granular and rigid environments. The exemplary system can introduce a highly reliable adaptability, addressing this gap in the market. The exemplary foot system is also straightforward to manufacture, as it primarily consists of readily available materials. The exemplary system can utilize commonly used components and 3D-printed parts and motors, ensuring scalability for prototyping and testing.

Current state-of-the-art robots do not feature heavy ankle-foot systems, as foot mass impacts their dynamics, especially at high speeds, due to the effects of moment of inertia. A heavier proximal limb makes controlling the rest of the robot more challenging. However, the lightweight exemplary foot system (e.g., 150 grams for RP embodiment and 500 grams for TB embodiment), configured with torque density actuators and 3D printing technology, can mitigate these constraints, enhancing control and efficiency.

### Conclusion

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special-purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] U.S. Pat. No. 8,403,081B2.
[2] International Patent Application No. WO 2017/068037.
[3] U.S. Pat. No. 5,337,494A.
[4] U.S. Pat. No. 12,201,190B2.
[9] U.S. Patent Application No. 2024/0114994A1.

What is claimed:

1. A foot system for a legged robot comprising:
a set of movable cleats coupled to at least one guided assembly, including a first guided assembly, or a portion thereof;
a sole section having a set of slits, wherein the sole section is configured to be in mechanical contact with a ground surface comprising soft soil or hard soil;
a casing section fixably coupled to the sole section to form a housing to encapsulate the set of movable cleats and the guided assembly, or a portion thereof; and
a controller configured to direct an actuator located in the casing section to move the set of movable cleats through the set of slits between a stowed position distal to the sole section and a deployed position proximal to the sole section along a substantial portion of the housing.

2. The foot system of claim 1, wherein the at least one guided assembly is configured to (i) move the set of movable cleats through the set of slits from the stowed position to the deployed position, to extend the set of movable cleats into the ground surface; and (ii) move the set of movable cleats through the set of slits from the deployed position to the stowed position, to retract the set of movable cleats from the ground surface.

3. The foot system of claim 2, wherein the first guided assembly comprises:
a frame fixably coupled to the set of movable cleats; and
at least one guide threaded shaft, including a first guide threaded shaft operatively coupled to the frame, wherein the first guide threaded shaft includes (i) a threading portion extending through the frame within the housing and (ii) a head portion protruding the casing section, wherein the threading portion is configured to rotationally and/or linearly actuate to move, via the frame within the first guided assembly, the set of movable cleats through the set of slits between the stowed position and the deployed position.

4. The foot system of claim 3, further comprising:
at least one actuator, including a first actuator as the actuator operatively coupled to the first guide threaded shaft, or the head portion thereof, wherein the first actuator is configured to drive the head portion of the first guide threaded shaft to cause the threading portion of the first guide threaded shaft to rotationally and/or linearly actuate to move, via the frame within the first guided assembly, the set of movable cleats through the set of slits between the stowed position and the deployed position.

5. The foot system of claim 4, wherein the controller is configured to:
actuate the at least one actuator to drive the head portion of the at least one guide threaded shaft to cause the threading portion of the at least one guide threaded shaft to rotationally and/or linearly actuate to move, via the frame within the at least one guided assembly, the set of movable cleats through the set of slits from the stowed position to the deployed position, to extend the set of movable cleats into the ground surface;
determine an amount of current drawn by the at least one actuator when the at least one actuator drives the head portion of the at least one threaded shaft; and
in response to the determined amount of current exceeding a predefined current threshold, yield by allowing the set of moveable cleats to move from the deployed position to the stowed position, or actuate the at least one actuator to drive the head portion of the at least one guide threaded shaft to cause the threading portion of the at least one guide threaded shaft to rotationally and/or linearly actuate to move, via the frame within the at least one guided assembly, the set of movable cleats through the set of slits from the deployed position to the stowed position, to retract the set of movable cleats from the ground surface.

6. The foot system of claim 4, further comprising:
a sensor situated within the housing, wherein the sensor is configured to capture an image of the ground surface, and wherein the controller is configured to:
receive, via the sensor, the captured image of the ground surface;
determine, via a detection algorithm or a trained AI model, type of the ground surface using the received captured image at every predefined period of time; and
actuate the first actuator to drive the head portion of the first guide threaded shaft, based on the determined type of the ground surface.

7. The foot system of claim 6, wherein in response to the determined type of the ground surface being granular, the controller is further configured to actuate, in a first direction, the first actuator to drive the head portion of the first guide threaded shaft to cause the threading portion of the first guide threaded shaft to rotationally and/or linearly actuate to move, via the frame within the first guided assembly, the set of movable cleats through the set of slits from the stowed position to the deployed position, to extend the set of movable cleats into the ground surface.

8. The foot system of claim 6, wherein in response to the determined type of the ground surface being non-granular, the controller is further configured to actuate, in a second direction, the first actuator to drive the head portion at least one guide threaded shaft to cause the threading portion of the first guide threaded shaft to rotationally and/or linearly actuate to move, via the frame within the first guided assembly, the set of movable cleats through the set of slits from the deployed position to the stowed position, to retract the set of movable cleats from the ground surface.

9. The foot system of claim 6, wherein in response to detecting, via the sensor, only one foot of the legged robot being in mechanical contact with the ground surface, the controller is configured to actuate, in the first direction, the first actuator to drive the head portion of the first guide threaded shaft to cause the threading portion of the first guide threaded shaft to rotationally and/or linearly actuate to move, via the frame within the first guided assembly, the set of movable cleats through the set of slits from the stowed position to the deployed position, to extend the set of movable cleats into the ground surface.

10. The foot system of claim 3, further comprising:
a second set of movable cleats situated within the housing;
a second guided assembly fixably coupled to the second set of movable cleats, wherein the second guided assembly is situated within the housing, and wherein the second guided assembly comprises:
a second frame fixably coupled to the second set of movable cleats,
a second guide threaded shaft operatively coupled to the second frame, wherein the second guide threaded shaft includes (i) a threading portion extending through the second frame within the housing and (ii) a head portion protruding the casing section, wherein the threading portion of the second guide threaded shaft is configured to rotationally and/or linearly actuate to move, via the second frame within the second guided assembly, the second set of movable cleats between the stowed position and the deployed position along the substantial portion of the housing; and
a second actuator operatively coupled to the second guide threaded shaft, or the head portion thereof, wherein the second actuator is configured to drive the head portion of the second guide threaded shaft to cause the threading portion of the second guide threaded shaft to rotationally and/or linearly actuate to move, via the second frame within the guided assembly, the second set of movable cleats through the set of slits between the stowed position and the deployed position.

11. The foot system of claim 1, wherein cleats in the set of cleats form an interdigitated pattern or a multi-angled pattern.

12. The foot system of claim 1, wherein cleats in the set of cleats are parallel to one another.

13. The foot system of claim 1, wherein the legged robot is selected from the group consisting of a one-legged robot, a bipedal robot, a tripedal robot, a quadrupedal robot, a hexapod robot, and an octopod robot.

14. The foot system of claim 2, wherein the first guided assembly comprises:
a frame fixably coupled to the set of movable cleats, wherein the frame includes a rack;
a pinion operatively coupled to the rack, wherein the pinion, when being driven, is configured to actuate the rack to move, via the frame within the first guided assembly, the set of movable cleats through the set of slits between the stowed position and the deployed position; and
at least one actuator fixably coupled to the sole section, wherein the at least one actuator is configured to drive the pinion to actuate the rack to move, via the frame within the first guided assembly, the set of movable cleats through the set of slits between the stowed position and the deployed position along the substantial portion of the housing.

15. The foot system of claim 14, wherein the controller is configured to:
actuate, in a first direction, the at least one actuator to drive the pinion to actuate the rack to move, via the frame within the first guided assembly, the set of movable cleats through the set of slits from the stowed position to the deployed position, to extend the set of movable cleats into the ground surface;
determine an amount of current drawn by the at least one actuator when the at least one actuator drives the pinion; and
in response to the determined amount of current exceeding a predefined current threshold, yield by allowing the set of moveable cleats to move from the deployed position to the stowed position, or actuate, in a second direction, the at least one actuator to drive the pinion to actuate the rack to move, via the frame within the first guided assembly, the set of movable cleats through the set of slits from the deployed position to the stowed position, to retract the set of movable cleats from the ground surface.

16. The foot system of claim 14, further comprising:
a sensor situated within the housing, wherein the sensor is configured to capture an image of the ground surface, and wherein the controller is configured to:
receive, via the sensor, the captured image of the ground surface;
determine, via a detection algorithm or a trained AI model, type of the ground surface using the received captured image at every predefined period of time; and
actuate the at least one actuator to drive the pinion to actuate the rack to move, via the frame within the first guided assembly, the set of movable cleats through the set of slits, based on the determined type of the ground surface.

17. The foot system of claim 16, wherein in response to the determined type of the ground surface being granular, the controller is further configured to:
actuate, in a first direction, the at least one actuator to drive the pinion to actuate the rack to move, via the frame within the first guided assembly, the set of movable cleats through the set of slits from the stowed position to the deployed position, to extend the set of movable cleats into the ground surface.

18. The foot system of claim 16, wherein in response to the determined type of the ground surface being non-granular, the controller is further configured to:
actuate, in a second direction, the at least one actuator to drive the pinion to actuate the rack to move, via the frame within the first guided assembly, the set of movable cleats through the set of slits from the deployed position to the stowed position, to retract the set of movable cleats from the ground surface.

19. A legged robot comprising:
a foot system for a legged robot comprising:
a set of movable cleats coupled to at least one guided assembly, or a portion thereof;
a sole section having a set of slits, wherein the sole section is configured to be in mechanical contact with a ground surface comprising soft soil or hard soil;
a casing section fixably coupled to the sole section to form a housing to encapsulate the set of movable cleats and the at least one guided assembly, or a portion thereof; and
a controller configured to direct an actuator located in the casing section to move the set of movable cleats through the set of slits between a stowed position distal to the sole section and a deployed position proximal to the sole section along a substantial portion of the housing.

20. The legged robot of claim 19, wherein the at least one guided assembly is configured to (i) move the set of movable cleats through the set of slits from the stowed position to the deployed position, to extend the set of movable cleats into the ground surface; and (ii) move the set of movable cleats through the set of slits from the deployed position to the stowed position, to retract the set of movable cleats from the ground surface.

21. The legged robot of claim 20, wherein the at least one guided assembly comprises:
a frame fixably coupled to the set of movable cleats; and
at least one guide threaded shaft operatively coupled to the frame, wherein the at least one guide threaded shaft includes (i) a threading portion extending through the frame within the housing and (ii) a head portion protruding the casing section, wherein the threading portion is configured to rotationally and/or linearly actuate to move, via the frame, the set of movable cleats through the set of slits between the stowed position and the deployed position.

22. The legged robot of claim 21, wherein the foot system further comprises:
at least one actuator operatively coupled to the at least one guide threaded shaft, or the head portion thereof, wherein the at least one actuator is configured to drive the head portion of the at least one guide threaded shaft to cause the threading portion of the at least one guide threaded shaft to rotationally and/or linearly actuate to move, via the frame, the set of movable cleats through the set of slits between the stowed position and the deployed position; and
a sensor situated within the housing, wherein the sensor is configured to capture an image of the ground surface, and wherein the controller is configured to:
receive, via the sensor, the captured image of the ground surface;
determine, via a detection algorithm or a trained AI model, type of the ground surface using the received captured image at every predefined period of time; and
actuate the at least one actuator to drive the head portion of the at least one guide threaded shaft, based on the determined type of the ground surface.
